(19) United States
(12) Patent Application Publication
(10) Pub. No.: US 2005/0212493 A1
(43) Pub. Date: Sep. 29, 2005

(54) Capacitor system

(75) Inventors: Tatsushi Yamaguchi, Tokyo (JP); Takahiro Ootsuka, Tokyo (JP); Nobuhide Furuya, Tokyo (JP); Shigeru Watanabe, Tokyo (JP); Michio Okamura, Kanagawa (JP)

Correspondence Address: BIRCH STEWART KOLASCH & BIRCH, PO BOX 747, FALLS CHURCH, VA, 22040-0747, US

(73) Assignees: TOKO ELECTRIC CORPORATION; OKAMURA LABORATORY INCORPORATED

(21) Appl. No.: 10/992,667

(22) Filed: Nov. 22, 2004

(30) Foreign Application Priority Data
Mar. 29, 2004 (JP) 2004-093993

(51) Int. Cl. H02J 1/00

(52) U.S. Cl. 320/166

(57) ABSTRACT

Provided is a capacitor system which makes the best use of the performance of capacitors while reducing power loss. The capacitor system includes a plurality of capacitors, parallel monitors which are respectively connected in parallel to the capacitors and initialize voltages of the capacitors to a predetermined value, a plurality of changeover switches which function to switch a connection state of the capacitors connected in series, and a bank switching function of switching the connection state of the capacitors by alternately turning the changeover switches on and off to provide a predetermined voltage. The changeover switches are alternately turned on and off while maintaining a simultaneous ON time to ensure continuous flow of a charge/discharge current.

### BACKGROUND OF THE INVENTION

1) Field of the Invention

The present invention relates to a capacitor system having a capacitor-voltage initializing function of making the voltages of a plurality of capacitors equal to a predetermined value using parallel monitors, and a bank switching function which switches the connection state of plural capacitors to make the fluctuation range of the output voltage smaller.

2) Description of the Related Art

A capacitor system which is configured by combining a plurality of capacitors each comprised of an electric double layer capacitor or the like with an electronic circuit which achieves the initializing function and the bank switching function is known as an ECS or ECaSS (Energy Capacitor System or Energy Capacitor Systems, respectively, both are registered trademarks) (see non-Patent Literature 1: “Electric double layer capacitor and capacitor system, Version 2”, Chapter 5 “Techniques in electrical circuits”,pp. 129 to 164, by Nikkan Kogyo Shimbun, published on Feb. 28th, 2001).

The initializing function charges each capacitor to a given voltage by using parallel monitors, respectively connected to the individual capacitors, in order to prevent the assigned voltages of the capacitors from being non-uniform due to variations in the capacitances of plural capacitors connected in series and the initial voltage. The regular use of the function can set the operational points of the individual capacitors back to the original points and can allow for safe usage of the capacitors at rated voltages.

The bank switching function changes the connection state of plural capacitors by means of switches in such a way that the capacitors are connected in parallel when the voltages of the individual capacitors are high and the capacitors are connected in series when those voltages are low, thereby making the fluctuation range of the output voltage of the capacitor system as a whole and the fluctuation range of the voltage at the time of charging smaller to stabilize the capacitor system. One known bank switching function is a so-called shift type bank switching method which can allow the same withstand voltage and capacitance elements to be used for all capacitors.

The inventor has already proposed a capacitor system equipped with the initializing function and bank switching function as disclosed in Patent Literature 1 (Japanese Patent Application Laid-open No. 2003-111286 Publication, claims 1, 2, and 5, Paragraphs [0024] to [0029], and FIGS. 2 to 4).

The capacitor system disclosed in the Patent Literature 1 has a control unit that achieves an initializing function by means of parallel monitors and a bank switching function by a switching unit and is designed in such a way that the control unit performs initialization using the parallel monitors in the vicinity of a voltage at which the switch unit performs bank switching (i.e., performs initialization immediately before or after bank switching).

FIG. 1A shows one example of a capacitor bank in a capacitor system (so-called shift type double bank switching circuit). C1 to C4 are capacitors, and S1a, S1b, S2a, S2b, and S3 are changeover switches. For the sake of convenience, parallel monitors are not shown in the diagram.

As apparent from FIG. 1A, connection states shown in FIGS. 1B, 1C and 1D can be realized equivalently by switching the changeover switches S1a, S1b, S2a, S2b, and S3. By switching the changeover switches S1a, S1b, S2a, S2b, and S3, the connection state of the capacitors C1 to C4 is changed in the order of FIG. 1B to FIG. 1C to FIG. 1D at the time of discharging, and is changed in the order of FIG. 1D to FIG. 1C to FIG. 1B at the time of discharging to thereby keep the output voltage of the capacitor system as a whole at the predetermined value.

Connection states shown in FIGS. 1E and 1F will be discussed later.

With reference to FIGS. 1A to 1F, when some of the capacitors (e.g., capacitors C2 and C3) are changed to parallel connection from series connection, for example, when the connection state in FIG. 1D is changed to the connection state in FIG. 1C, the changeover switches S2a and S2b in FIG. 1A are turned on simultaneously. This forcibly makes the voltages of the capacitors C2 and C3 whose connection state has been changed to parallel connection from series connection each to each other by charging/discharging according to the difference between both voltages and, thus causes pseudo initialization.

If the set voltage for initialization by the parallel monitors is selected to be nearly a set voltage for full charge, which is not affected by bank switching, those capacitors whose connection states are changed to parallel connection undergo an initialization with different conditions twice in one charge cycle.

FIG. 2 exemplifies a change in the voltage of one capacitor (e.g., capacitor C2 or C3) at the time of charging/discharging. T_{A} is a bank switching point from series connection (state in FIG. 1D) to parallel connection (state in FIG. 1C), V_{A} is a set voltage for bank switching, T_{B} is a full-charge target point, and V_{B} is a set voltage for full charge.

When discharging is started from the full-charge state and charging takes place with some suspending period, if all the capacitor voltages are made equal to one another at the time of full charging, there is a variation in voltage which is inversely proportional to the capacitance of each of capacitors to be connected in parallel at the bank switching point T_{A} at which the capacitor voltage is about half the full-charge set voltage V_{B}. Conventionally, bank switching is executed in this state to forcibly set two capacitors to parallel connection, so that a cross current flows between the capacitors, thereby causing power loss.

As charging is performed toward the full-charge set voltage V_{B} from the bank switching point T_{A}, a variation in voltage which is inversely proportional to the capacitance occurs again. Accordingly, the operation of the parallel monitors consumes the current of the capacitors whose voltages tend to become higher, so that an operation to set the voltages of all the capacitors equal to one another takes place. The greater the variation in capacitor voltage, the more intense the operation becomes, thereby making the power loss larger. The power loss becomes larger as the difference between the set voltage for initialization by the parallel monitors and the set voltage at the time of bank switching is larger.

According to the invention described in the Patent Literature 1, initialization is executed in the vicinity of the capacitor voltage at the time of bank switching (the set voltage for initialization by the parallel monitors is set to V_{C} or V_{C}′ around the set voltage Vₐ at the time of bank switching in FIG. 2 to make the point of initialization approach the point T_{A}).

Accordingly, even with a variation in capacitance in the capacitors, the difference between the voltages of the capacitors to be connected in parallel becomes small at the time of bank switching. The cross current between the capacitors when they are forcibly connected in parallel by switching can be reduced, thus ensuring a reduction in power loss and an improvement of energy efficiency.

However, even if the capacitors are initialized with the set voltage for initialization being set to V_{C} or V_{C}′, a variation in voltage which is inversely proportional to the capacitance of the capacitor still occurs until the capacitors are charged to the full-charge voltage V_{B}. Provided that the set voltage for initialization is set to V_{C} which is half the full-charge voltage V_{B}, even if the capacitors are initialized with V_{C} voltage to set the capacitor voltages equal to one another, a variation in voltage at the point where the voltages of the capacitors reach the full-charge voltage V_{B} still holds some level, though reduced to half as compared with the case where no initialization is performed. This voltage variation therefore becomes a factor of causing the operation of the parallel monitors to consume the current in the capacitors whose voltages tend to become higher, thereby resulting in power loss.

Therefore, a voltage margin for the variation should be taken into account at the stage of designing a capacitor system, necessitating the setting of a lower full charge voltage including the margin as compared with the intrinsic characteristic of the parallel monitors that initialize the capacitors with nearly the full-charge voltage V_{B}.

This means a reduction in stored energy which is expressed by:
U=CV²/2
where U is the stored energy of a capacitor, C is the capacitance of the capacitor, and V is the voltage of the capacitor, and does not allow for efficient use of the performance of the capacitors.

### SUMMARY OF THE INVENTION

It is an object of the present invention to provide a capacitor system which makes the best use of the performance of capacitors while reducing power loss.

To achieve the object, the present invention does not simultaneously connect a plurality of capacitors to be connected in parallel at the time of bank switching, but alternately connects those capacitors by alternately switching changeover switches on and off.

In the Patent Literature 1, as mentioned above, at the time of bank switching from the state in FIG. 1D to the state in FIG. 1C, the capacitors C2 and C3 are simultaneously connected in parallel by switching the changeover switches S2a and S2b in FIG. 1A simultaneously. In this case, as the time of bank switching is close to the initialization point, the voltage difference between the capacitors C2 and C3 to be connected in parallel at the time of bank switching is small, so that generation of the cross current can be restrained. When a voltage difference occurs due to a variation in the capacitance of each capacitor C2, C3 in a later charge period, the operation of the parallel monitors consumes the current of the capacitors whose voltages tend to become higher at the point where the voltage reaches the full charge voltage, thereby resulting in power loss.

In this respect, in the present invention, the changeover switches S2a and S2b in FIG. 1A are not turned on simultaneously, but are turned on and off alternately to realize the parallel connection state in FIG. 1C in a pseudo manner.

FIG. 3 is a timing chart showing the fundamental operations of the changeover switches S2a and S2b according to the present invention. When the changeover switches S2a and S2b are turned on and off as shown in FIG. 3 from the state in FIG. 1D, the series connection of the capacitors C1, C2, and C4 or the series connection of the capacitors C1, C3, and C4 is repeated alternately as shown in FIG. 1F.

This switching does not cause a chance of connecting the capacitors C2 and C3 in parallel, so that even if the voltages of the capacitors C2 and C3 differ from each other, the cross current is not produced and their voltages are not forcibly made equal to each other by exchange of the energy. Even when charging/discharging is performed while executing the bank switching operation by the ON/OFF actions of the changeover switches S2a and S2b, the capacitor voltage hardly deviates from the set voltage for initialization. It is therefore possible to provide a capacitor system which makes the best use of the performance of capacitors together with initialization by the parallel monitors.

Likewise, when the connection state in FIG. 1C is changed to the connection state in FIG. 1B, the changeover switches S1a and S1b are not turned on simultaneously, but are turned on and off alternately to alternately repeat the series connection of the capacitors C1 and C2 or the series connection of the capacitors C3 and C4 as shown in FIG. 1E. Both of the states achieve the parallel connection state in FIG. 1B in a pseudo manner.

Besides a mechanical relay, a semiconductor switch, such as a thyristor, a GTO thyristor, a transistor, a MOSFET or an IGBT, can be used as the changeover switches.

FIG. 4 shows an example of a changeover switch using MOSFETs. A series circuit of a MOSFET SF-1 and a reverse blocking diode D1 and a series circuit of a MOSFET SF-2 and a reverse blocking diode D2 are connected in a reverse parallel order, thereby configuring a bidirectional switch circuit. The switch circuit is used as one changeover switch (e.g., changeover switch S1a) in FIG. 1A. As the MOSFETs SF-1 and SF-2 are independently controlled at the time of charging and at the time of discharging, one directional current can be allowed to flow.

FIG. 5 is a timing chart for the changeover switches S2a and S2b at the time of changing the state in FIG. 1D to the state in FIG. 1C when the shift type double bank switching circuit is configured using changeover switches as shown in FIG. 4.

According to the present invention, while basically the changeover switches S2a and S2b are alternatively turned on and off as shown in FIG. 3, a simultaneous ON time of about 10 μsec to 1 msec is provided as indicated by shading in FIG. 5 in order to continuously let the. charge/discharge current of each capacitor flow. Even with the changeover switches S2a and S2b set simultaneously on, the changeover switches S2a and S2b let the current flow only in one direction at the time of charging and at the time of discharging, so that the cross current is not produced. When the changeover switches S2a and S2b are switched to be on for one second and off for one second, for example, though the operational periods are not particularly restrictive, the influence of charging/discharging for the simultaneous ON time on the initialization is negligible.

To sum up, a first aspect of the present invention provides a capacitor system that comprises a plurality of capacitors; a plurality of changeover switches which function to make parallel connection of the capacitors connected in series; and a bank switching function of switching a connection state of the capacitors by alternately turning the changeover switches on and off to provide a predetermined voltage.

A second aspect of the present invention provides a capacitor system that comprises a plurality of capacitors; parallel monitors which are respectively connected in parallel to the capacitors and initialize voltages of the capacitors to a predetermined value; a plurality of changeover switches which function to make parallel connection of the capacitors connected in series; and a bank switching function of switching a connection state of the capacitors by alternately turning the changeover switches on and off to provide a predetermined voltage.

A third aspect of the present invention provides the capacitor system according to the first or the second aspect, wherein the changeover switches are alternately turned on and off while maintaining a simultaneous ON time to ensure continuous flow of a charge/discharge current.

A fourth aspect of the present invention provides the capacitor system according to the first or the second aspect, wherein each of the changeover switches has a semiconductor switch such as MOSFETs and can independently let a current to flow bidirectionally and block the current.

A fifth aspect of the present invention provides the capacitor system according to the third aspect, wherein each of the changeover switches has a semiconductor switch such as MOSFETs and can independently let a current to flow bidirectionally and block the current.

### BRIEF DESCRIPTION OF THE DRAWINGS

FIGS. 1A to 1F are diagrams showing the connection states of capacitors by bank switching;

FIG. 2 is a diagram showing voltage changes when capacitors are charged and discharged;

FIG. 3 is a timing chart showing the fundamental switching operations at the time of bank switching according to the present invention;

FIG. 4 is a configurational diagram of a changeover switch using MOSFETs;

FIG. 5 is a timing chart showing the operation of changeover switches according to the present invention;

FIG. 6 is a general configurational diagram of a charge/discharge system including a capacitor system according to an embodiment of the present invention;

FIGS. 7A to 7D are diagrams showing the connection states of the capacitors according to the embodiment of the present invention;

FIG. 8 is a timing chart showing the operation of changeover switches according to the embodiment of the present invention;

FIG. 9 is another timing chart showing the operation of changeover switches according to the embodiment of the present invention;

FIG. 10 is a diagram showing voltage changes according to the embodiment of the present invention;

FIG. 11 is another diagram showing voltage changes according to the embodiment of the present invention; and

FIG. 12 is a diagram showing voltage changes according to a comparative example of the present invention.

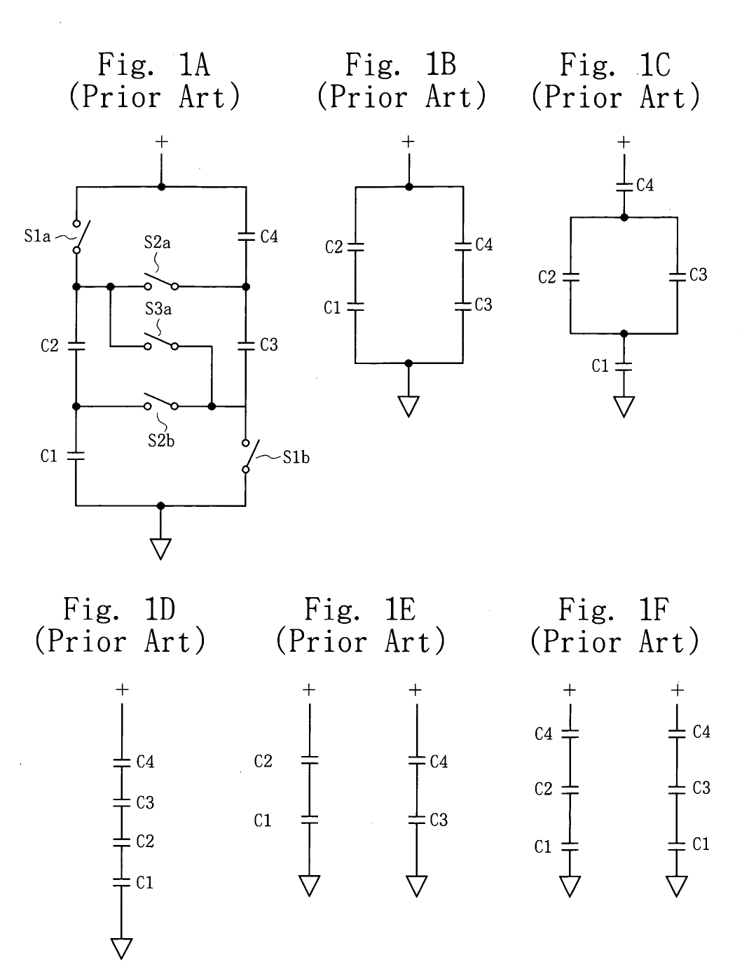

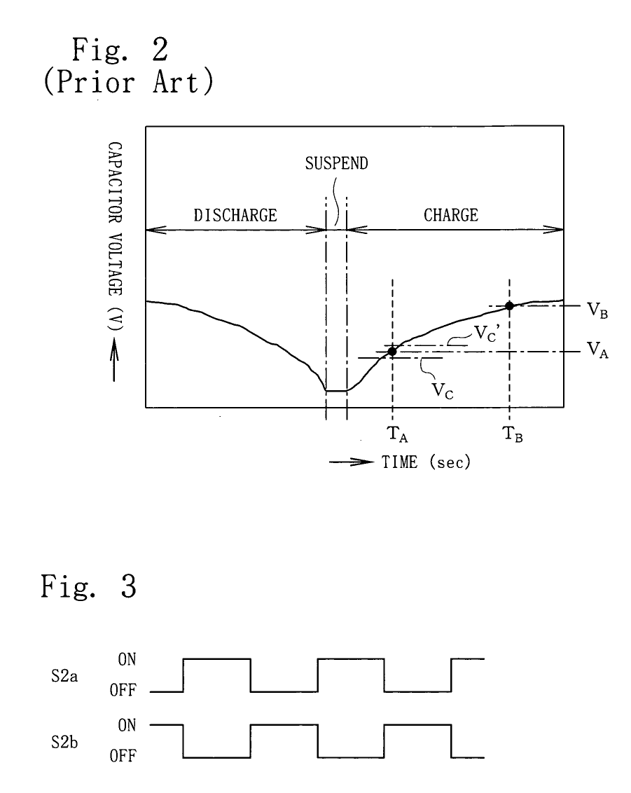

### DETAILED DESCRIPTION OF THE PREFERRED EMBODIMENT

Preferred embodiments of the present invention are explained below with reference to the accompanying drawings.

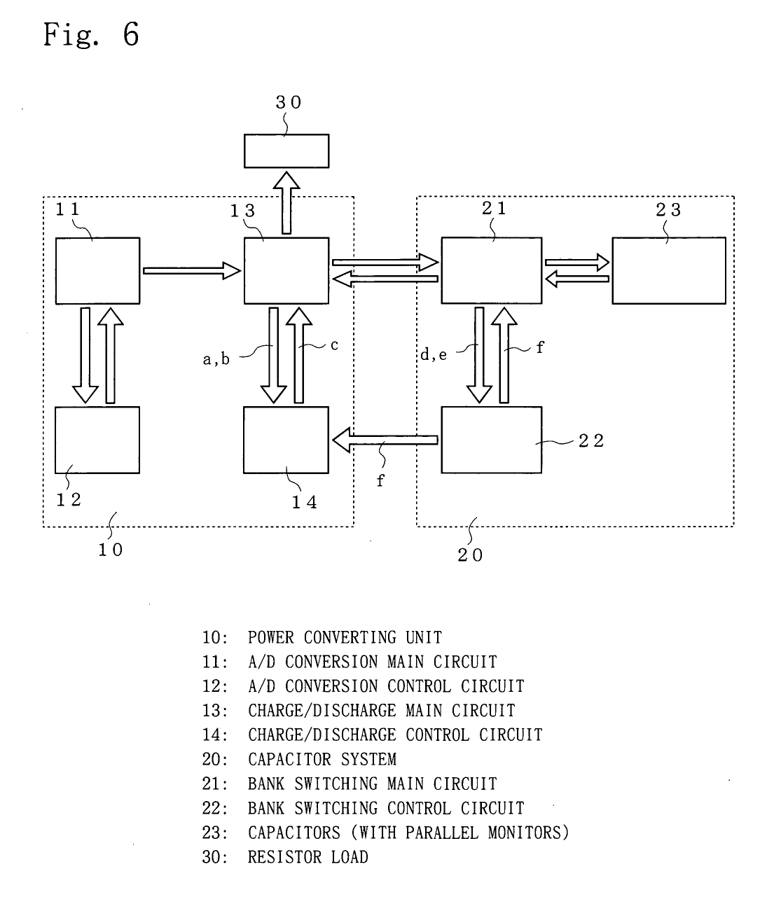

FIG. 6 is a general configurational diagram of a charge/discharge system which includes a capacitor system 20 according to one embodiment of the present invention, a power converting unit 10 which charges and discharges the capacitor system 20, and a resistor load 30 which is supplied with power from the capacitor system 20.

The outline of the operation is that a group of capacitors 23 of the capacitor system 20 is charged with constant power from a charge/discharge main circuit 13 in the power converting unit 10 or the power charged in the capacitor group 23 is discharged to the resistor load 30 with constant power via a bank switching main circuit 21.

The power converting unit 10 includes an A/D conversion main circuit 11 as a power converting circuit to convert AC power to DC power, an A/D conversion control circuit 12, a charge/discharge main circuit 13 which performs a charging/discharging operation on the capacitors and performs a discharging operation on the resistor load 30, and a control circuit 14 which performs PWM (Pulse Width Modulation) control on the charge/discharge main circuit 13.

The capacitor system 20 includes the bank switching main circuit 21 equipped with a plurality of changeover switches which switches the connection state of a plurality of capacitors, a control circuit 22 for the circuit 21, and the capacitor group 23. An electric double layer capacitor with a parallel monitor is used as each capacitor in the capacitor group 23. The circuit shown in FIG. 5 in the Patent Literature 1, for example, can be used as the parallel monitor.

The charge/discharge control circuit 14 receives a capacitor charge/discharge voltage signal a and a capacitor charge/discharge current signal b from the charge/discharge main circuit 13, generates a PWM signal c to set those signals equal to set values, and controls the ON/OFF actions of semiconductor switching elements in the charge/discharge main circuit 13.

The bank switching control circuit 22 determines whether the mode is a charge mode or a discharge mode from a charge/discharge current signal d sent from the bank switching main circuit 21. The bank switching control circuit 22 detects that the capacitor voltage has reached the set voltage for bank switching based on a charge/discharge voltage signal e, and sends a switch signal f to the bank switching main circuit 21 to execute bank switching.

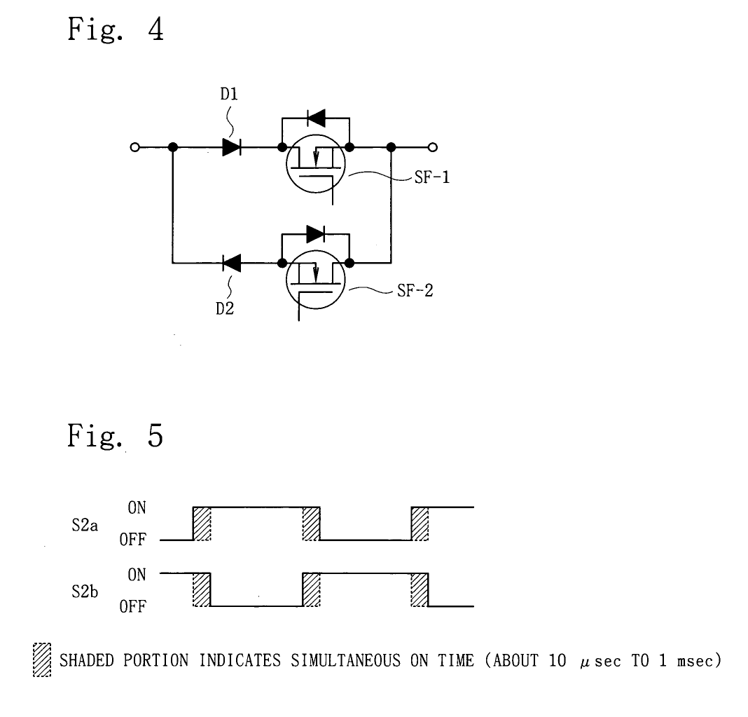

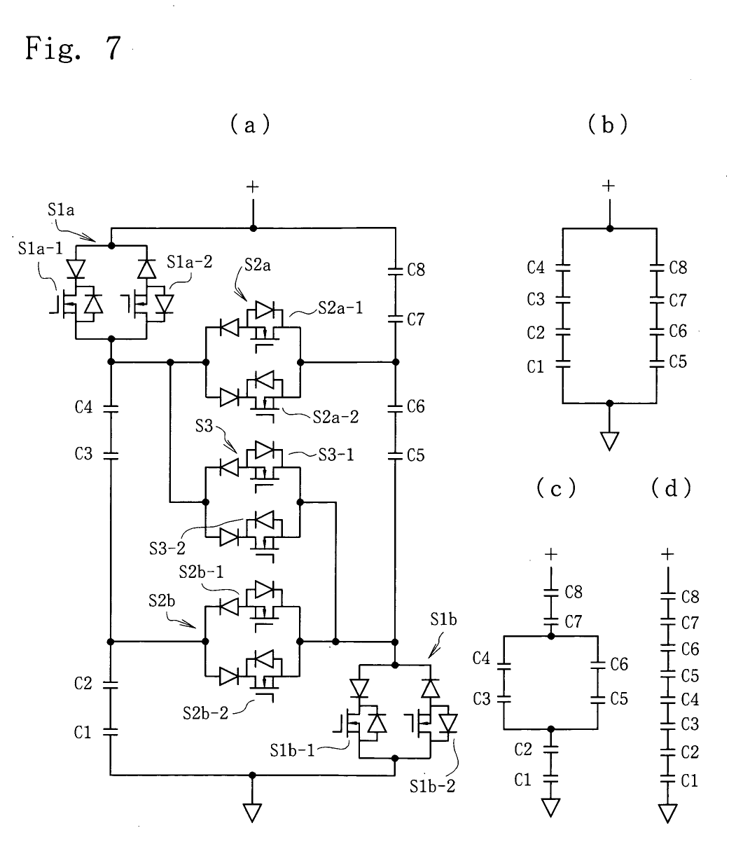

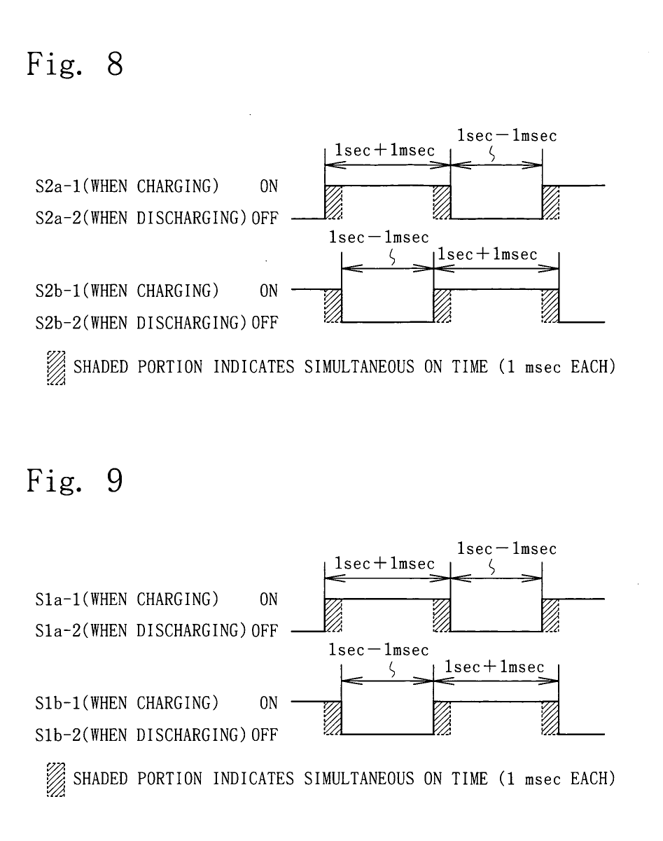

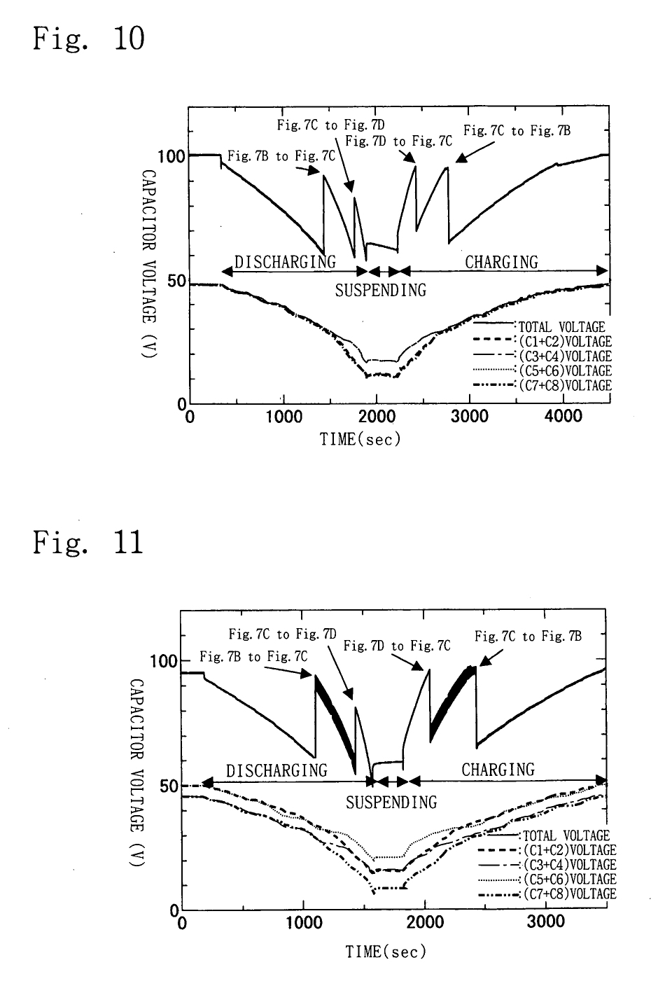

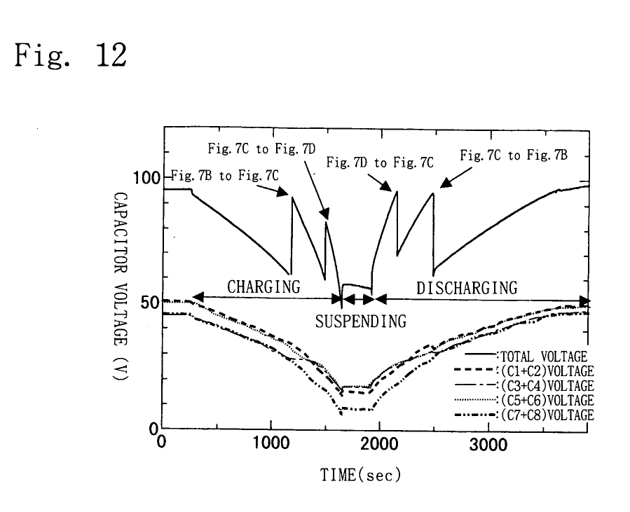

FIG. 7A is a diagram showing a specific example of the configuration of the capacitor group 23. A shift type double bank switching is constituted by capacitors C1 to C8 and changeover switches S1a, S1b, S2a, S2b, and S3. Two series circuits each having a semiconductor switch, comprised of a MOSFET, and a reverse blocking diode and connected in a reverse parallel order, as in FIG. 4, are used for each of the changeover switches S1a, S1b, S2a, S2b, and S3. S1a-1 and S1a-2, S1b-1 and S1b-2, S2a-1 and S2a-2, S2b-1, and S2b-2, and S3-1 and S3-2 are semiconductor switches which respectively constitute the changeover switches S1a, S1b, S2a, S2b, and S3.

Of the semiconductor switches, the semiconductor switches S1a-1, S1b-1, S2a-1, S2b-1, and S3-1 are controlled at the time of charging, and the semiconductor switches S1a-2, S1b-2, S2a-2, S2b-2, and S3-2 are controlled at the time of discharging, to perform charging/discharging of the individual capacitors.

### Example The following will describe an example with the configuration when charging/discharging is executed while performing bank switching of the capacitor group 23.

First, a capacitor module with a parallel monitor, which has a rated voltage of DC 24 V, a rated capacitance of 333 F and stored energy of 27 Wh, for example, is used for each of the capacitors (electric double layer capacitors) C1 to C8. Bank switching is done in the order of FIG. 7B to FIG. 7C, and to FIG. 7D at the time of discharging, is done in the order of FIG. 7D to FIG. 7C, and to FIG. 7B at the time of charging, and the bank switching voltage is set to DC 60 V at the time of discharging, and set to DC 96 V at the time of charging,.

Although each of the connection states in FIG. 7B and 7C includes a parallel circuit of capacitors, the changeover switches S1a and S1b are alternately turned on and off and the changeover switches S2a and S2b are alternately turned on and off, except for the simultaneous ON time, so that the series circuit of the capacitors C3 and C4 and the series circuit of the capacitors C5 and C6 are not normally connected in parallel, as shown in, for example, FIG. 7C. That is, in connection with FIG. 7C, the series circuit of the capacitors C1, C2, C3, C4, C7, and C8 and the series circuit of the capacitors C1, C2, C5, C6, C7, and C8 are alternately repeated, and FIG. 7C merely shows the combination of those connection states in pseudo fashion. The same is applied to FIG. 7B.

In this sense, the states in FIG. 7B and FIG. 7C can be regarded as pseudo parallel connection states.

In the pseudo parallel connection states in FIGS. 7B and 7C, the changeover switches S1a and S1b and the changeover switches S2a and S2b are alternately turned on and off about every one second, with the simultaneous ON time of 1 msec provided at the transition between the ON and OFF states, as shown in FIGS. 8 and 9.

With reference to FIG. 8, as the semiconductor switches S2a-1 and S2b-1 are alternately turned on and off at the time of charging, the series connection of the capacitors C1, C2, C3, C4, C7, and C8 and the series connection of the capacitors C1, C2, C5, C6, C7, and C8 are repeated alternately, thereby achieving the pseudo parallel connection state in FIG. 7C.

With reference to FIG. 9, as the semiconductor switches S1a-1 and S1b-1 are alternately turned on and off at the time of charging, the series connection of the capacitors C1, C2, C3, and C4, and the series connection of the capacitors C5, C6, C7, and C8 are repeated alternately, thereby achieving the pseudo parallel connection state in FIG. 7B.

In the connection state in FIG. 7D, the changeover switch S3 is turned on continuously.

The discharge power is set constant at the discharge output terminal of the charge/discharge main circuit 13 while the charge power is set constant at the charge output terminal of the charge/discharge main circuit 13.

FIG. 10 shows voltage changes of the capacitors when charging/discharging and bank switching of the capacitors C1 to C8 are executed under the aforementioned conditions.

In FIG. 10, the voltage of the entire capacitors, the voltage of the capacitors (C1+C2), the voltage of the capacitors (C3+C4), the voltage of the capacitors (C5+C6), and the voltage of the capacitors (C7+C8) are measured. Before discharging is started, the connection state is the one in FIG. 7B and the total voltage then is 100 V for 4-series connection state of 25 V which is the initialization voltage of the capacitor module. The voltage of the capacitors (C1+C2), the voltage of the capacitors (C3+C4), the voltage of the capacitors (C5+C6), and the voltage of the capacitors (C7+C8) are each 50 V in a 2-series connection states of 25 V

At the time discharging is started, the semiconductor switches S1a-2 and S1b-2 are turned on and off alternately to about every one second, thereby realizing the connection state in FIG. 7B in a pseudo manner.

The operation states of the semiconductor switches S1a-2 and S1b-2 at this time are as shown in FIG. 9, and the simultaneous ON time for permitting the continuously flow of the discharge current is secured between the semiconductor switches S1a-2 and S1b-2.

As shown in FIG. 10, the voltages of the capacitors (C1+C2), the capacitors (C3+C4), the capacitors (C5+C6), and the capacitors (C7+C8) fall at nearly the same rate as the discharging starts, and when the total voltage becomes about 60 V, the ON/OFF actions of the semiconductor switches S1a-2 and S1b-2 are stopped and the changeover switches S2a-2 and S2b-2 are turned on and off, thereby ensuring bank switching from FIG. 7B to FIG. 7C.

At this time, the operation states of the semiconductor switches S2a-2 and S2b-2 are as shown in FIG. 8, and the simultaneous ON time for permitting the continuously flow of the discharge current is secured between the semiconductor switches S2a-2 and S2b-2.

Bank switching from FIG. 7B to FIG. 7C instantaneously increases the total voltage.

Thereafter, the voltage drops for the capacitors (C3+C4) and (C5+C6), which are connected in parallel in pseudo fashion, are smaller than the voltage drops for the capacitors (C1+C2) and (C7+C8), which are connected in series. When the total voltage becomes about 60 V again, the ON/OFF actions of the semiconductor switches S2a-2 and S2b-2 are stopped and the semiconductor switches S3-1 and S3-2 are turned on, thereby ensuring bank switching from FIG. 7C to FIG. 7D to instantaneously increase the total voltage.

As charging is started after a suspension time, the voltages of the capacitors (C1+C2), (C3+C4), (C5+C6), and (C7+C8) rise in the opposite change with respect to the discharge, and when the total voltage becomes about 96 V, the semiconductor switches S3-1 and S3-2 are turned off and the semiconductor switches S2a-1 and S2b-1 are turned on and off to ensure bank switching from FIG. 7D to FIG. 7C, thereby instantaneously dropping the total voltage.

At this time, the operation states of the semiconductor switches S2a-1 and S2b-1 are as shown in FIG. 8, and the simultaneous ON time for permitting the continuously flow of the charge current is secured between the semiconductor switches S2a-1 and S2b-1.

As the total voltage increases to about 96 V again, the ON/OFF actions of the semiconductor switches S2a-1 and S2b-1 are stopped and the semiconductor switches S1a-1 and S1b-1 are turned on and off to ensure bank switching from FIG. 7C to FIG. 7B, thereby causing the total voltage to instantaneously drop again.

At this time, the operation states of the semiconductor switches S1a-1 and S1b-1 are as shown in FIG. 9, and the simultaneous ON time for permitting the continuously flow of the charge current is secured between the semiconductor switches S1a-1 and S1b-1.

After bank switching from FIG. 7C to FIG. 7B, the state where the voltages of the capacitors (C1+C2), (C3+C4), (C5+C6), and (C7+C8) become nearly equal to one another is maintained until charging is finished.

Even if charging/discharging is executed while performing bank switching in the above-described manner, the voltages of nearly all the capacitors return to the original voltages at a high voltage level. This proves that energy exchange (so-called pseudo initialization) has not taken place between the capacitors to be connected in parallel in pseudo fashion at the time of bank switching and that power loss originated from energy exchange has not occurred.

In the example in FIG. 10, as variations in the capacitances of the capacitors in use are small, the advantage of the present invention is not clear. To simulate variations in the capacitances of the individual capacitors, therefore, the capacitors (C3+C4) and (C7+C8) are discharged with 5 V after fully charged, and the charging/discharging operation as described above is performed in that state. The results are shown in FIG. 11.

FIG. 12 shows, as a comparative example, the results in a case where the changeover switches are simultaneously turned on to connect the capacitors in parallel at the same time at the time of bank switching, as done in the prior art, without executing the switching operations as shown in FIGS. 8 and 9.

In FIGS. 11 and 12, the total voltage before initiation of discharging is 95 V which is lower by 5 V than the voltage (100 V) for 4-series connection state of 25 V which is the initialization voltage of the capacitor module. The voltages of the capacitors (C1+C2) and (C5+C6) are each 50 V in a 2-series connection state of 25 V Further, the voltages of the capacitors (C3+C4) and (C7+C8) are 45 V lower by 5 V than the voltage in a 2-series connection states of 25 V.

With reference to FIG. 11, as the changeover switches S1a and S1b and the changeover switches S2a and S2b are alternately turned on and off about every one second as shown in FIGS. 8 and 9 at the time of connecting the capacitors in a pseudo parallel state, the state where the voltages of the capacitors (C3+C4) and (C7+C8) are lower by 5 V than the voltages of the capacitors (C1+C2) and (C5+C6) at the time of initiation of discharging can be re-created after bank switching from FIG. 7C to FIG. 7B and can be maintained until the end of charging. This means that even if the capacitances of the capacitors vary before usage or during usage, energy exchange (pseudo initialization) does not take place between the capacitors to be connected in parallel in pseudo fashion at the time of bank switching.

In the example in FIG. 12 where the capacitors are simultaneously connected in parallel as done in the prior art, by way of contrast, the state where the voltages of the capacitors (C3+C4) and (C7+C8) are lower by 5 V than the voltages of the capacitors (C1+C2) and (C5+C6) at the time of initiation of discharging cannot be re-created after bank switching from FIG. 7C to FIG. 7B and the voltage difference of 5 V become approximately half or about 2.5 V.

This phenomenon occurs because the voltages are made even by the energy exchange between the capacitors (C3+C4) and (C5+C6) simultaneously connected in parallel at the time of bank switching from FIG. 7B to FIG. 7C at the time of discharging, which will be an equivalent result of initialization of the capacitors. Therefore, if the voltages of the capacitors (C1+C2), (C3+C4), (C5+C6), and (C7+C8) at the time of initiation of discharging are all made equal to one another, when there are variations in the capacitances of the capacitors, it is assumed that executing bank switching during the charging/discharging period causes a variation in capacitor voltage at a high voltage level after execution of charging/discharging.

It is apparent from the results given in FIGS. 10 to 12 that for the changeover switches S1a and S1b and changeover switches S2a and S2b which switch the connection state of plural capacitors between a series connection state and a parallel connection state, when those switches which are to be turned on to establish parallel connection of plural capacitors are alternately turned on and off, executing charging/discharging while performing bank switching does not bring about the complete parallel connection state of plural capacitors in that process. Accordingly, no energy exchange takes place between the capacitors and consequently no pseudo initialization is caused, so that power loss does not occur. Further, a variation in capacitor voltage at the end of charging becomes smaller, so that wasteful power consumption by the frequent operation of the parallel monitors does not occur.

When capacitors to be connected in parallel are connected in parallel simultaneously as done in the prior art, execution of charging/discharging while performing bank switching results in pseudo initialization in each cycle, resulting in power loss. Further, it is predicted that as the parallel monitors frequently operate at the end of charging to eliminate a variation in capacitor voltage, wasteful power consumption and reduction in charging/discharging efficiency occur.

Although the foregoing description has been given of examples of bank switching from FIG. 7D to FIG. 7C and from FIG. 7C to FIG. 7B, the present invention can be adapted to every possible parallel connection in multiple stages.

The switches whose operational period is not particularly limited need not be operated at several kilohertz to several hundred kilohertz as required for a switching converter, but the operational period can be selected according to the usage, such as ON and OFF states being switched every one second, for example. That is, setting the adequate operational period for the switches makes the switching loss fall within a level of an error as compared with normal loss. Switching noises or the like can be handled according to the switching converter, and a change in voltage which is caused by switching of capacitors with two different voltages, for example, C2 and C3, does not raise any particular problem because normally a bank switching power supply of this type is designed on the premise that a significantly large voltage change occurs at the time of bank switching.

According to the present invention, at the time of changing the connection state of a plurality of capacitors from series connection to parallel connection, the changeover switches are alternately turned on and off to avoid simultaneous parallel connection of plural capacitors. Accordingly, the cross current does not flow between plural capacitors, so that power loss can be reduced.

Even when a plurality of capacitors to be connected in parallel are charged and discharged while performing bank switching, a deviation from the initialization voltage hardly occurs, so that the voltage of each capacitor does not vary at the end of charging. It is therefore unlikely that the frequent operation of the parallel monitors consumes power and lowers the charge/discharge efficiency. The present invention can therefore realize a capacitor system which makes the best use of the performance of capacitors.

1. A capacitor system comprising:
a plurality of capacitors;
a plurality of changeover switches which function to make parallel connection of the capacitors connected in series; and
a bank switching function of switching a connection state of the capacitors by alternately turning the changeover switches on and off to provide a predetermined voltage.

2. A capacitor system comprising:
a plurality of capacitors;
parallel monitors which are respectively connected in parallel to the capacitors and initialize voltages of the capacitors to a predetermined value;
a plurality of changeover switches which function to make parallel connection of the capacitors connected in series; and
a bank switching function of switching a connection state of the capacitors by alternately turning the changeover switches on and off to provide a predetermined voltage.

3. The capacitor system according to any one of claim 1 or 2, wherein the changeover switches are alternately turned on and off while maintaining a simultaneous ON time to ensure continuous flow of a charge/discharge current.

4. The capacitor system according to any one of claim 1 or 2, wherein each of the changeover switches comprises a semiconductor switch and can independently let a current to flow bidirectionally and block the current.

5. The capacitor system according to claim 3, wherein each of the changeover switches comprises a semiconductor switch and can independently let a current to flow bidirectionally and block the current.
